(19) United States
(12) Patent Application Publication
(10) Pub. No.: US 2024/0326526 A1
(43) Pub. Date: Oct. 3, 2024

(54) Methods and Systems for Automatic Condition Analysis of Vehicle Tires

(71) Applicant: Snap-on Incorporated, Kenosha, WI (US)

(72) Inventors: Patrick S. Merg, Hollister, CA (US); Roy S. Brozovich, Campbell, CA (US)

(21) Appl. No.: 18/191,629

(22) Filed: Mar. 28, 2023

(51) Int. Cl. B60C 25/05; B60C 25/00

(52) U.S. Cl. CPC B60C 25/0554; B60C 25/002; B60C 25/0515

(57) ABSTRACT

Examples embodiments relate to techniques for automatic condition analysis of vehicle tires. A robotic device may initially obtain air pressure data corresponding to a vehicle tire from a first sensor and perform a first comparison between an air pressure level of the vehicle tire and a threshold air pressure level. Responsive to the air pressure level of the vehicle tire exceeding the threshold air pressure level, the robotic device may use a mechanical manipulator to rotate the vehicle tire and obtain sensor data representing an outer surface of the vehicle tire during rotation from a second sensor. The robotic device may then perform a second comparison between sensor data representing the outer surface of the vehicle tire and a model for the vehicle tire. The robotic device may then use the second comparison to generate a diagnostic output that represents a condition of the vehicle tire.

### BACKGROUND

Most vehicles are serviced at least once during their useful life. In many instances, a vehicle is serviced at a facility with professional mechanics (e.g., technicians). In other instances, technicians and/or other professionals (or non-professionals) who are servicing the vehicle can do so at other locations, such as on the road. The technicians can use any of a variety of computerized tools and/or non-computerized tools to service (e.g., repair) any of the wide variety of mechanical vehicle components on a vehicle. As technology advances, various types of robotic devices are developed to perform tasks that can assist users. By extension, there exists a desire to use robotic devices for efficient and accurate performance of some vehicle servicing tasks.

### SUMMARY

Example implementations relate to techniques for automatically analyzing and diagnosing the condition of vehicle tires. Such techniques may be performed by robotic devices configured with mechanical and computing systems executing software that together enable the autonomous detection, measurement, and evaluation of a vehicle tire's condition. After analyzing a tire, a robotic device may output a diagnostic report that articulates the condition of the vehicle tire along with recommendations for when to check the tire again and/or how many more miles that tire may have available before becoming unsafe to use. In some instances, a robotic device can change a vehicle tire when the condition warrants a replacement tire or in response to a request from the vehicle's owner.

In one aspect, an example method for automatic condition analysis of a vehicle tire is provided. The method involves obtaining, by a robotic device and from a first sensor, air pressure data corresponding to the vehicle tire and, based on the air pressure data, performing a first comparison between an air pressure level of the vehicle tire and a threshold air pressure level. The method also involves, responsive to the air pressure level of the vehicle tire exceeding the threshold air pressure level, rotating, by the robotic device using a mechanical manipulator, the vehicle tire in a first direction. The method also involves obtaining, by the robotic device and from a second sensor, sensor data representing an outer surface of the vehicle tire during rotation of the vehicle tire, and performing a second comparison between sensor data representing the outer surface of the vehicle tire and a model for the vehicle tire. The method also involves, based on the second comparison, generating, by the robotic device, a diagnostic output that represents a condition of the vehicle tire.

In another aspect, an example system for automatic condition analysis of a vehicle tire is provided. The system includes a first sensor, a second sensor, and a robotic device having at least one processor and a mechanical manipulator. The robotic device is communicatively coupled to the first sensor and the second sensor. In addition, the robotic device is configured to: obtain, from the first sensor, air pressure data corresponding to the vehicle tire and, based on the air pressure data, perform a first comparison between an air pressure level of the vehicle tire and a threshold air pressure level. The robotic device is also configured to, responsive to the air pressure level of the vehicle tire exceeding the threshold air pressure level, rotate the vehicle tire in a first direction using the mechanical manipulator. The robotic device is further configured to obtain, from the second sensor, sensor data representing an outer surface of the vehicle tire during rotation of the vehicle tire and perform a second comparison between sensor data representing the outer surface of the vehicle tire and a model for the vehicle tire. The robotic device is also configured to generate a diagnostic output that represents a condition of the vehicle tire based on the second comparison.

In yet another aspect, an example non-transitory computer-readable medium configured to store instructions for automatic condition analysis of a vehicle tire, that when executed by a robotic device comprising one or more processors, causes the robotic device to perform operations. The operations involve obtaining, from a first sensor, air pressure data corresponding to the vehicle tire, and, based on the air pressure data, performing a first comparison between an air pressure level of the vehicle tire and a threshold air pressure level. The operations also involve, responsive to the air pressure level of the vehicle tire exceeding the threshold air pressure level, rotating, using a mechanical manipulator, the vehicle tire in a first direction, and obtaining, from a second sensor, sensor data representing an outer surface of the vehicle tire during rotation of the vehicle tire. The operations also involve performing a second comparison between sensor data representing the outer surface of the vehicle tire and a model for the vehicle tire, and generating a diagnostic output that represents a condition of the vehicle tire based on the second comparison.

These as well as other aspects, advantages, and alternatives will become apparent to those of ordinary skill in the art by reading the following detailed description, with reference where appropriate to the accompanying drawings.

### BRIEF DESCRIPTION OF THE DRAWINGS

FIG. 1 illustrates a tire mounted to a wheel, according to one or more example embodiments.

FIG. 2 is a block diagram representing a computing system, according to one or more example embodiments.

FIG. 3 illustrates a server device cluster, according to one or more example embodiments.

FIG. 4 illustrates a system for cloud-based computing and communication, according to one or more example embodiments.

FIG. 5 is a block diagram representing a robotic device, according to one or more example embodiments.

FIG. 6A illustrates an artificial neural network (ANN) architecture, according to one or more example embodiments.

FIG. 6B illustrates training the ANN, according to one or more example embodiments.

FIG. 7 is a flow chart of a method, according to one or more example embodiments.

FIG. 8 is a schematic illustrating a conceptual partial view of a computer program for executing a computer process on a computing system, arranged according to at least some embodiments presented herein.

All the figures are schematic, not necessarily to scale, and generally only show parts which are necessary to elucidate example embodiments, wherein other parts may be omitted or merely suggested.

### DETAILED DESCRIPTION

Example methods and systems are described herein. It should be understood that the words “example,” “exemplary,” and “illustrative” are used herein to mean “serving as an example, instance, or illustration.” Any implementation or feature described herein as being an “example,” being “exemplary,” or being “illustrative” is not necessarily to be construed as preferred or advantageous over other implementations or features.

The example implementations described herein are not meant to be limiting. It will be readily understood that aspects of the present disclosure, as generally described herein, and illustrated in the figures, can be arranged, substituted, combined, separated, and designed in a wide variety of different configurations, all of which are explicitly contemplated herein.

### I. Overview

Advancements in computing and sensor capabilities have helped contribute to an increase in the deployment of various mechanical systems to perform operations within various contexts. For instance, robotic devices are one type of mechanical systems that are being increasingly used for warehouse and manufacturing applications. Although the configuration of robotic devices can vary based on the particular tasks the robotic devices are designed to perform, each robotic device typically includes hardware with one or more manipulators that are controllable by an onboard computing system that can perform techniques by executing software.

Robotic devices can be programmed to perform various tasks and often used due to their ability to safely perform routine tasks with accurate precision. In some cases, onboard processors use sensor data from one or multiple sensors communicatively coupled to the robotic device to perform operations according to the robotic device's surroundings. Because robotic devices can operate effectively for long stretches with minimal delays for periodic servicing of components, many industries continue to explore different ways that robotic devices can be adopted to perform a variety of tasks.

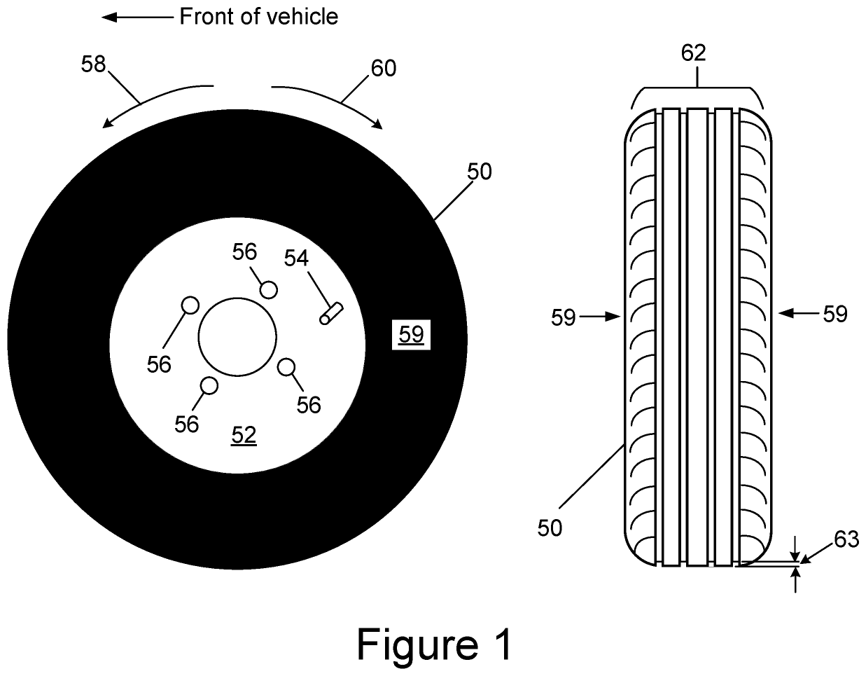

Example embodiments described herein involve using robotic devices to automatically analyze and service vehicle tires. FIG. 1 shows a tire 50 (e.g., a vehicle tire) mounted to a wheel 52. The tire 50 and wheel 52 can form an enclosed space (not shown) for storing air (i.e., an air space). A valve stem 54 is typically attached to the wheel. The valve stem 54, also referred to as a fill valve, can be used to add air into the air space or to remove air from the air space. In some instances, a tire pressure monitor system (TPMS) sensor is also attached to the wheel. The TPMS sensor can output a signal indicative of an air pressure within the air space. For purposes of this description, a pressure of air within the air space can be referred to as air pressure data measured from the vehicle tire, air pressure level of the vehicle tire, or the like. The wheel include a lug hole 56 to allow portions of threaded lugs to pass through the lug hole 56. The tire includes a sidewall 59 on opposite sides of the tire 50.

A direction of rotation 58, 60 is also indicated in FIG. 1. For an embodiment in which the tire 50 and wheel 52 are mounted on a vehicle having its front end located as indicated in FIG. 1, then the direction of rotation 58 can be considered a forward direction of rotation, and the direction of rotation 60 can be considered a reverse direction of rotation. The left-most view of the tire 50 shown in FIG. 1 shows a sidewall of the tire 50. The right-most view of the tire 50 shown in FIG. 1 shows a portion of a tread area 62 of the tire 50. The tread area 62 can have depths measured to provide an indication of remaining tire life and/or tire wear. FIG. 1 shows an example tire depth measurement 63.

An original equipment manufacturer (OEM) of a vehicle or a tire can specify an air pressure or air pressure range for optimum use of a tire. The specified air pressure can be a threshold air pressure, a threshold air pressure level, or an upper pressure level and a lower pressure level marking a range for the air pressure. The specified air pressure can be a single value, such as 35 pounds per square inch (PSI), or 240 Kilopascal (kPa), or a range of values such as 32 to 35 PSI or 220 to 240 kPa. In at least some embodiments, a tire having an air pressure level less than the specified air pressure for the tire can be considered under-inflated or partially deflated, whereas a tire having an air pressure level greater than the specified air pressure for the tire can be considered over-inflated. A tire having an air pressure level equal the specified air pressure or within the range of values for the tire can be considered properly inflated.

At least some of the example embodiments are applicable to airless tires. These embodiments can further include a processor determining that a tire to be analyzed is an airless tire and responsively determining that checking an air pressure level and comparison to a specified air pressure level is not required for the airless tire. Although an airless tire does not an air space for storing air, various objects, like nails, screws, wire, or glass, can penetrate into an airless tire such that use of the tire embedded with an object that penetrated the tire can lead to undesirable tire performance.

Examples of robotic devices are presented that are configured to perform disclosed techniques in order to analyze the conditions of vehicle tires autonomously, which can occur without requiring intervention from a technician or another user. As such, performance of disclosed techniques can involve the generation of diagnostic outputs that enable technicians and vehicle owners to understand the conditions of a vehicle's tires and potentially anticipate when a tire requires replacement.

Evaluation of a vehicle tire by a robotic device can involve the robotic device measuring and analyzing the condition of specific parameters of the vehicle tire (e.g., tread condition, outer surface condition, and air pressure level). The robotic device can compare the measured parameters relative to one or multiple models that provide baselines that enable the robotic device to determine if parameters fall outside desired ranges or have other irregularities that decrease the overall condition of the tire.

In some embodiments, the model or models used for evaluating a tire's health can depend on the age of the vehicle tire, the brand of the vehicle tire, the vehicle that is using the vehicle tire, the estimated miles driven by the vehicle tire, the air pressure level of the tire, and/or other factors. For instance, a robotic device may use a model that has certain baselines when evaluating parameters of an older tire that has been used for a threshold distance (e.g., 30,000 miles) and a model that conveys other baselines when evaluating parameters of a newer tire that has been used for a shorter distance (e.g., 5,000 miles). As an example when selecting a model or models for analyzing a tire, the robotic device can factor the tire's brand, environment of use (e.g., warmer climates or colder climates), and parameters related to the vehicle that is using the tire (e.g., weight and ride height of the vehicle). In some examples, the robotic device may factor the type of vehicle since different vehicles may impact tire wear and tear differently. For instance, electric vehicles may cause tires to wear down faster than vehicles that use an internal combustion engine. In some examples, the evaluation of a tire may involve comparing measurements to representative numbers or numeric ranges. For instance, the robotic device may compare the tire's air pressure level to an air pressure range. In some examples, a model used by the robotic device to evaluate a tire may depend on the vehicle's make and model that uses the tire. As such, the robotic device may obtain a vehicle make identifier and a vehicle model identifier by obtaining on-board diagnostic parameters from the vehicle or using image recognition on images of the vehicle.

The diagnostic output generated by a robotic device can provide data that enables a user to decide whether or not to replace the vehicle tire tested by the robotic device. In particular, the diagnostic output may take the form of a digital report that includes text-based descriptions describing the condition of different parts of the tire and potential recommendations (e.g., when to have the vehicle tire checked again). The output can be generated based on different factors tested and analyzed by the robotic device. In some embodiments, potential issues detected during analysis of the tire can be weighed by the robotic device in order to generate a recommendation, such as a prediction for the next inspection of the vehicle tire. Some factors considered when generating the diagnostic output may include tread depth, age of tire analysis, visual inspection data, local driving conditions and vehicle usage, and manufacturer recommendations.

In some examples, a robotic device may include mechanical manipulators that enables the robotic device to analyze and potentially move a tire based on the estimated condition of the tire. For instance, the robotic device can determine that the tire's condition is below a threshold condition and subsequently modify the tire's position, such as moving the tire into a pile for subsequent recycling. In some cases, moving the tire can involve the robotic device physically removing the tire off a vehicle and replacing the tire. In addition, evaluation of a tire's condition can involve comparing the current state of one or more elements of the tire relative to one or more baselines. For instance, the robotic device can obtain and compare sensor measurements of different elements of the tire relative to properties displayed by the same elements on a new version of the tire.

To further illustrate, an example embodiment may involve a robotic device designed to use one or multiple onboard processors to perform disclosed techniques. The robotic device can be communicatively coupled to one or multiple sensors. The robotic device can obtain sensor data from the sensor(s) via a wired connection and/or wireless connection. For instance, the robotic device can include onboard sensors, which may include one or multiple cameras, radar, proximity sensors, sonar, lidar, and/or photo-electronic sensors, among other possible sensors. The robotic device can also include a communication module that allows the robotic device to communicate with sensors, other computing devices, and/or an onboard computing system of a vehicle.

Analysis of a vehicle tire may involve the robotic device obtaining air pressure data corresponding to the vehicle tire from one or multiple sensors, such as an air pressure sensor or air pressure gauge. In some implementations, a computing system on the robotic device may communicate with a sensor coupled to the valve stem of a vehicle tire (e.g., the valve stem 54 of tire 50) via a technician or a user in order to obtain the air pressure data. In other implementations, the robotic device may use sensor data and computer vision or another technique to detect and connect an air pressure sensor to the valve stem of the vehicle tire in order to obtain the air pressure data.

In some examples, air pressure data may be estimated via one or multiple sensors that are not coupled to the tire. For instance, air pressure data can be obtained from a TPMS. The robotic device may receive air pressure data by reading parameter IDs (PIDs) indicative of tire pressure and/or communicating with a vehicle system that can provide the air pressure data based on PIDs. The PIDs may be obtained from a computing system located onboard the vehicle. As an example, the robotic device may be configured to operate as a diagnostic scan tool to obtain the PIDs. The robotic device may also communicate and receive PID data from a scan tool used by a technician or a user.

Based on the air pressure data measured from the vehicle tire, the robotic device can determine an air pressure level of the vehicle tire and compare the tire's air pressure level to one or more air pressure values, such as an air pressure threshold or an air pressure range. The air pressure level may be specified in pounds per square inch (PSI), kilopascal (kPa), or in some other units, and the comparison may be used by the robotic device to determine subsequent operations for analyzing the vehicle tire's condition. For instance, the robotic device may compare the current air pressure level measured for the tire with a threshold pressure level. The threshold pressure level may represent a lower bound pressure value specified by the manufacturer of the vehicle tire or another source. When the current air pressure level exceeds the threshold pressure level, the robotic device may determine that the tire is inflated at least to a level that enables further analysis. In some cases, the comparison of the air pressure level of the tire with one or more air pressure values may indicate that the tire is partially deflated. The robotic device may then perform different operations depending on the results of the comparison.

In some examples, the robotic device may compare the air pressure level of the tire relative to an air pressure range specified by the OEM of the tire. Temperature and other factors can be considered when analyzing the air pressure level of the vehicle tire. For instance, the air pressure range or threshold used for the comparison can depend on the current temperature of the environment. In addition, in some instances, the robotic device may access the air pressure value or values from another source, such as a remote computing device that stores values for a variety of tires. The robotic device may obtain values based on parameters of the tire, such as the type, brand, size, and/or age of the tire. Other sources specifying the air pressure level or levels for analyzing the vehicle tire may be used.

Evaluation of the vehicle tire's condition may further involve the robotic device using a mechanical manipulator to initiate rotation of the vehicle tire. Rotating the vehicle tire can allow the robotic device to obtain sensor data measuring the outer surface of the tire and check the balance of the vehicle tire. In practice, a robotic device can be designed to rotate the vehicle tire in various ways within examples. For instance, a robotic device may use a rolling manipulator to rotate the vehicle tire in some examples. The tire can be coupled to the rolling manipulator, which enables the rolling manipulator to rotate the tire. Coupling the rolling manipulator to the tire can vary with example embodiments. For instance, the rolling manipulator can physically connect to a wheel on which the tire is mounted or a wheel hub to which the wheel is mounted.

In other instances, the robotic device may use a wheel balancer to rotate the vehicle tire. The tire can be positioned on the wheel balancer or the robotic device may couple the wheel balancer to the tire. A robotic device can have other types of mechanical manipulators that attach to a vehicle tire and enable analysis of the outer surface. In some examples, the direction and speed of rotation can depend on the air pressure analysis performed by the robotic device. For instance, the speed of rotation can vary based on how much the measured air pressure level of the vehicle tire exceeds the air pressure threshold or how much the measured air pressure differs from the air pressure range specified by the OEM of the tire. In some embodiments, the robotic device may use a tire changer that can be used to move and reposition tires relative to a vehicle (e.g., replace a damaged tire).

In addition, the robotic device may analyze a vehicle tire when it is positioned on a vehicle in some examples. For instance, the vehicle can be lifted at a shop or via another lift mechanical system and its transmission shifted into in neutral, which enables the robotic device to rotate the tire as the tire is positioned on the vehicle. In other examples, the robotic device may analyze the vehicle tire when the tire is physically separate from a vehicle. A vehicle may also drive or be driven onto rollers associated with a robotic device. The rollers can then enable rotation of a vehicle tire during analysis.

In some examples, the robotic device may start rotating the tire after comparing the air pressure level of the vehicle tire to one or more threshold air pressure levels. For instance, the robotic device may determine that the measured air pressure level of the vehicle tire exceeds a first threshold air pressure level and falls below a higher, second threshold air pressure level, which may indicate that the tire is within a desired air pressure range for the tire. In this case, the first threshold air pressure level and the second threshold pressure level represent the lower and upper boundaries of the range for desired air pressure for the tire, which can depend on the manufacturer of the tire, the type of vehicle and/or manufacturer of the vehicle, and/or the distance already traveled by the tire (e.g., the age and use of the tire). During rotation of the tire, the robotic device can obtain sensor data from one or multiple sensors in order to analyze the tire's condition. For instance, the robotic device may check the balance of the tire by rotating the tire at one or multiple speeds and in one or both directions of rotation (e.g., the direction of rotation 58 and the direction of rotation 60). As an example, the robotic device may increase and/or decrease the rotation speed to check the tire's balance.

The robotic device may obtain sensor data that represents the tire's outer surface (e.g., the sidewall 59 and/or the tread area 62) during rotations of the tire in order to evaluate the condition of the tire's outer surface. For instance, the robotic device may obtain images of the outer surface from a camera and/or depth measurements of the tire's outer surface from a photo-electronic surface as the tire rotates. In some examples, the robotic device may receive depth measurements from a depth camera system, which may be physically connected to the robotic device in some cases. As an example, the depth camera system can include a depth camera D435 available from the Intel Corporation of Santa Clara, California, or some other depth camera system. The sensor(s) can be physically coupled to the robotic device in some examples, which may enable the robotic device to adjust the position of the sensor(s) relative to the vehicle tire.

In some embodiments, evaluation of the tire's outer surface an involve using one or multiple models. For instance, the robotic device can compare sensor measurements with a model specific to the tire in order to estimate the tire's condition. In an example embodiment, the model for the tire depends on the type of sensor data used by the robotic device and represents the tire in an optimal condition, such as a brand new state or an ideal condition that depends on the mileage associated with the tire. As such, the robotic device may then generate a diagnostic output that represents a condition of the vehicle tire based on comparing sensor data representing the vehicle tire's condition with one or multiple models for the tire. The diagnostic output can be provided to the owner of the vehicle, the technician, and/or a remote computing device for storage and subsequent access. In practice, the robotic device may securely communicate the diagnostic output to other computing devices, such as a technician's device, smartphones, tablets, and computers, etc.

Different types of robotic devices may perform operations described herein. For instance, a robotic device may include a rolling manipulator that can cause the rotation of the vehicle tire. The rolling manipulator may be a cylindrical roller that can rotate proximate to a portion of the tire causing the tire to rotate as a result. The rolling manipulator can include or be coupled to a motor operatively coupled to an electrical power system configured to provide the motor with a first electrical signal to cause the motor to turn in a first direction and a second electrical signal to cause the motor to turn in a second direction. Another example robotic device may include a wheel balancer designed to rotate the vehicle tire.

In addition, the sensors used by a robotic device to perform operations related to detecting and evaluating vehicle tires can vary within examples. For instance, a robotic device may use a camera to detect the location of a vehicle tire relative to the robotic device's current position and also to subsequently engage the vehicle tire. After engaging the vehicle tire, the robotic device may use one or more sensors to obtain measurements of the vehicle tire that can indicate the vehicle tire's condition. For example, the robotic device may use a camera and a photo electronic sensor to capture measurements of the vehicle treads and other aspects of the vehicle tire. When a robotic device utilizes multiple sensors to measure aspects of each vehicle tire undergoing inspection, the evaluation of a vehicle tire may be based on a weighted combination of the sensor measurements from the multiple sensors.

The techniques utilized to measure and evaluate vehicle tires within examples can also differ. In some examples, a robotic device may initially obtain measurements of each vehicle tire undergoing evaluation as the robotic device rotates a vehicle tire in a first direction. For instance, the robotic device may measure treads, wheel balance, and other aspects using sensors as the vehicle tire is rotated in one direction at a constant speed by a manipulator on the robotic device. In addition, the robotic device may increase or decrease rotation speed and capture sensor measurements that are associated with the different rotation speeds. For instance, the robotic device may capture sensor data across a spectrum of rotation speeds. The robotic device may perform similar operations to capture sensor measurements while rotating a vehicle tire in the opposite direction as well.

In some embodiments, a robotic device may use artificial intelligence to perform one or more operations related to automatic condition analysis of vehicle tires (e.g., tire inspection and corresponding diagnosis). For example, the robotic device may couple the mechanical manipulator to a coupling point on the vehicle tire based on control instructions output by a neural network that is trained to determine the control instructions based on training data. The training data may include data collected from a number of iterations that involve coupling the mechanical manipulator to the coupling point on vehicle tires. For example, a computing system may obtain sensor data from multiple robotic devices to train the neural network to learn a particular task, such as detecting and engaging vehicle tires across different vehicles types and models. Training a neural network to assist with vehicle detection and evaluation can help robotic devices measure a variety of vehicle tires on various vehicle types and models despites differences across vehicle tires and placement of vehicle tires on vehicles.

In some examples, multiple robotic devices may communicate with a central system configured to maintain control instructions developed based on prior vehicle tire evaluations performed by one or more robotic devices. The central system may communicate with the different robotic devices via secure wireless communication and can enable each robotic device to access information (e.g., control instructions) that may assist the robotic device perform a vehicle tire evaluation. In other examples, robotic devices may operate as nodes within a distributed ledger, such as a blockchain. In these examples, the robotic devices may share instructions and communicate other information among each other without reliance on a central system.

Tire evaluation may also differ within examples and can depend on the sensor measurements obtained by a robotic device. In some examples, a robotic device (or a corresponding computing device) may evaluate sensor data depicting aspects of a vehicle tire to determine an amount of wear for the vehicle tire. In addition, evaluation of a vehicle tire may involve determining a tread mapping for the vehicle tire that indicates the conditions of the vehicle treads based on sensor data captured during rotation of the tire. During the evaluation of some vehicle tires, sensor measurements may show an irregularity in tread depth of a tire. As such, the robotic may use a tire's tread mapping to identify an irregularity in tread depth and estimate a position of the detected irregularity. When generating a diagnostic output representative of a tire's condition, the output may include an indication of the estimated position of the irregularity.

In some cases, evaluation of a vehicle tire may enable a robotic device to detect a foreign object coupled to the vehicle tire. For instance, sensor measurements may indicate the presence of a screw, nail, glass, or other foreign objects that may wedge between treads or into the tire during vehicle use. As such, the diagnostic output may indicate the presence of any foreign object on which vehicle tires for a vehicle.

Vehicle tire diagnosis techniques can also involve a robotic device using a sensor (e.g., a camera) to read the date code on the side of each tire and also inspect the side wall surface for cracks. The tire date code is a series of numbers and letters that is stamped on the sidewall of a tire and is used to indicate when the tire was manufactured. In some examples, the first two digits of the date code represents the week of the year, and the last two digits represent the year.

For instance, if the date code is 0521, the tire was manufactured in the 5th week of 2021. The robotic device may use the tire date code to identify one or more models for evaluating the health of the tire. In particular, the tire date code can be used to determine a vehicle tire's age and identify one or more models of tires having a similar age, thereby potentially increasing the accuracy of the robotic device's autonomous evaluation of the tire's health. In some cases, the robotic device may use the tire's age when formulating a recommendation for the tire's owner or a technician. For instance, when the date code indicates that a tire is more than a threshold age (e.g., 10 years old), the robotic device may be more likely to recommend replacing the tires. As such, the tire's age can be a factor considered along with other factors (e.g., identified issues using sensor data) when outputting an evaluation health report for the tire.

Tire evaluation can also involve a robotic device examining the remaining treadlife of each tire, which involves analyzing the remaining tread at one or multiple wear indicators of the tire. In general, a tire wear indicator is a small, raised bar that is embedded in the tread of a tire and designed to show how much tread is left on the tire. When the tread reaches the level of the tire wear indicator, the tire may need to be replaced. The robotic device can analyze the level of the tire wear indicator when formulating a health report for the tire. For instance, the robotic device can compare the height of the tire wear indicator relative to grooves, channels, or other portions of the outer surface of the tire to estimate an amount of wear on the tire. The robotic device can also identify when the tire's experiencing camber wear, feathered wear, or multiple problems.

In some embodiments, a computing system controlling the robotic device can accumulate data while servicing vehicle tires, which can be subsequently used to detect trends in tire wear and tear. For instance, a robotic device can include different types of sensors that can be used during tire evaluation. These sensors can provide sensor data that can be stored and accessed for later applications. For example, by leveraging the data obtained from sensors on the robotic device, the computing system can predict actions related to tire analysis and servicing, such as when certain tire models may require replacement. In addition, the computing systems of multiple robotic devices can share data associated with tire analysis and servicing, which can further enhance vehicle analysis predictions in a feedback loop. In some cases, weather conditions and other factors may be further considered when gathering data for subsequent trend detection.

The data and other information obtained through evaluating tires can be used by a machine learning model to generate a model that learned how to detect irregularities and other issues within sensor data of tires. For instance, data sets of sensor data can include labels that help train the model to learn how to detect and label the various issues that tires can experience. For instance, the model can be trained using labeled data to determine when a tire is overinflated, underinflated, experiencing camber, toe, feathered, or spotty/chopped wear as well as detecting other issues, such as foreign objects that punctured into the outer surface and wall bulges. The data can be generated by other robotic devices, technicians, or a combination of robotic devices and technicians.

In some cases, tire issues within measurements of tires can be identified and labeled via an autolabeling process trained to detect and label the issues. Autolabeling is a process that uses machine learning to automatically label data, which can be done by training a model on a small set of labeled data and then using that model to label new data. Autolabeling can be a useful tool for tasks such as image classification of issues detected in images of tires. Data can be autolabeled via transfer learning in disclosed techniques, which involves training a model on a large dataset of labeled data that is related to vehicle tire health evaluation. Some examples may involve using self-supervised learning for autolabeling, which involves using the unlabeled vehicle tire data to create a task that the model can learn to solve.

### II. Example Computing Devices and Cloud-Based Computing Environments

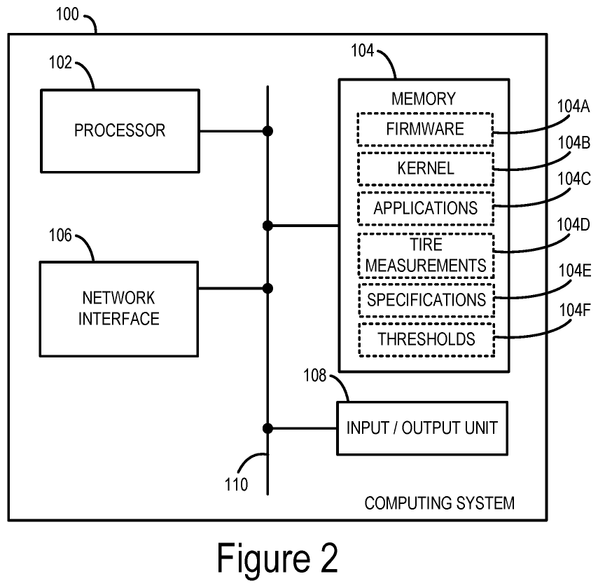

Referring now to the figures, FIG. 2 is a block diagram representing a computing system, according to one or more example embodiments. In the embodiment shown in FIG. 2, computing system 100 includes processor 102, memory 104, network interface 106, and an input/output unit 108, all of which may be coupled by a system bus 110 or a similar mechanism. In some embodiments, computing system 100 may include other components and/or peripheral devices (e.g., detachable storage, printers, and so on).

Computing system 100 may be a client device (e.g., a device actively operated by a user), a server device (e.g., a device that provides computational services to client devices), part of a robotic device, or some other type of computational platform. For example, computing system 100 may operate as part of a robotic device control system and/or operating system. The computing system 100 can be positioned on the robotic device, remote from the robotic device, or a combination of computing devices distributed on the robotic device communicating with computing devices positioned remote from the robotic device. In other examples, computing system 100 may serve as a control device that enables a user to provide control instructions to and/or monitor operations performed by one or more robotic devices. In some instances, computing system 100 may be a tablet, laptop, wearable computing device, or another type of device (e.g., a technician's specialty device).

Processor 102 may be one or more of any type of computer processing element, such as a central processing unit (CPU), a co-processor (e.g., a mathematics, graphics, or encryption processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory. This may include flash memory, hard disk drives, solid state drives, re-writable compact discs (CDs), re-writable digital video discs (DVDs), and/or tape storage, as just a few examples. Computing system 100 may include fixed memory as well as one or more removable memory units, the latter including but not limited to various types of secure digital (SD) cards. Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

In the embodiment shown in FIG. 2, memory 104 may include firmware 104A, kernel 104B, applications 104C, tire measurements 104D, specifications 104E, and/or thresholds 104F. Firmware 104A may be program code used to boot or otherwise initiate some or all of computing system 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and busses), of computing system 100. Applications 104C may be one or more user-space software programs, such as web browsers or email clients, as well as any software libraries used by these programs. In some examples, applications 104C may include one or more neural network applications. Memory 104 may also store data used by these and other programs and applications.

Tire measurements 104D can represent measurements obtained for one or multiple tires. For instance, tire measurements 104D can represent measurements of various types of tires across a range of conditions. In some examples, tire measurements 104D may include sensor data obtained via one or more sensors communicatively coupled to computing system 100.

In some embodiments, tire measurements 104D convey one or more of the height, width, and tread depth measured from side to side of the vehicle tire. Tire measurements 104D may also show cupping, which is a type of tire wear that results in small, shallow depressions or cups in the tire tread. This wear pattern can be caused by several factors, including worn or damaged suspension components, improper wheel alignment, or worn shock absorbers. Cupping can affect the handling and traction of the vehicle and can also increase the risk of hydroplaning on wet roads. Tire measurements 104D can also represent weight and pressure of the tire, the outer roundness of the tire (e.g., the distance from edge to center of the tire), and can show when the tire has a bulge or another pattern that may require some further analysis.

Specifications 104E can represent data associated with tires, such as tread mappings, weight, dimensions, etc. For instance, one or more models can be used to specify specifications 104E for evaluating tire conditions. Thresholds 104F can represent one or multiple thresholds or baselines used by computing system 100 to perform disclosed techniques. For instance, thresholds 104F can represent one or more air pressure threshold(s) and can be specific based on tire manufacturer, amount of wear of the tire, the vehicle using the tire, and other factors. In some cases, thresholds 104F can be based on specifications 104E.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (WI-FI®), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing system 100 may include Ethernet, BLUETOOTH®, and Wi-fi interfaces.

Input/output unit 108 may facilitate user and peripheral device interaction with computing system 100 and/or other computing systems. Input/output unit 108 may include one or more types of input devices, such as a keyboard, a mouse, one or more touch screens, sensors, biometric sensors, and so on. Similarly, input/output unit 108 may include one or more types of output devices, such as a screen, monitor, printer, and/or one or more light emitting diodes (LEDs). Additionally or alternatively, computing system 100 may communicate with other devices using a universal serial bus (USB) or high-definition multimedia interface (HDMI) port interface, for example.

In some examples, computing system 100 may be deployed to support a clustered architecture. Accordingly, the computing devices may be referred to as “cloud-based” devices that may be housed at various remote data center locations. In addition, computing system 100 may enable performance of embodiments described herein, including using neural networks and/or performing tasks related to vehicle tire maintenance. For instance, computing system 100 can perform disclosed operations, which may include gathering data that can be used to detect trends similar to a feedback loop. The trends can be used to determine how and when to change tires based on measurements of a tire's current condition, including providing suggestions which tires may be utilized in certain conditions. For instance, computing system 100 may suggest a particular brand of tire for use in warmer weather conditions and another brand for use in colder weather conditions based on sensor data obtained from other computing systems performing disclosed tire analysis techniques at various locations.

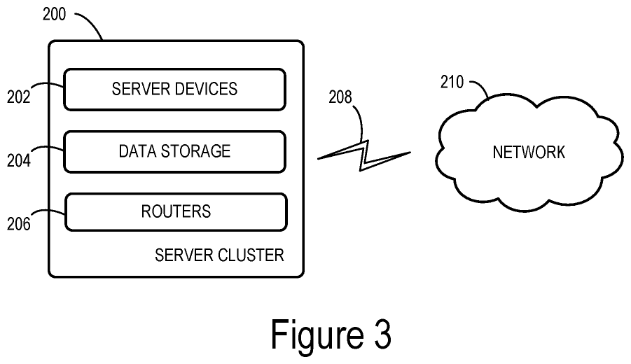

FIG. 3 illustrates a server device cluster, according to one or more embodiments. In the embodiment shown in FIG. 3, one or more operations of a computing device (e.g., computing system 100 shown in FIG. 2) may be distributed between server devices 202, data storage 204, and routers 206, all of which may be connected by a local cluster network. The number of server devices 202, data storages 204, and routers 206 in server cluster 200 may depend on the computing task(s) and/or applications assigned to server cluster 200. In some examples, server cluster 200 may perform one or more operations described herein.

Server devices 202 may perform various computing tasks of computing system 100. For example, one or more computing tasks can be distributed among one or more of server devices 202. To the extent that these computing tasks can be performed in parallel, such a distribution of tasks may reduce the total time to complete these tasks and return a result. For purpose of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be one or more data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via cluster network 208, and/or (ii) network communications between the server cluster 200 and other devices via communication link 210 to network 212.

Additionally, the configuration of routers 206 can be based at least in part on the data communication requirements of server devices 202 and data storage 204, the latency and throughput of the cluster network 208, the latency, throughput, and cost of communication link 210, and/or other factors that may contribute to the cost, speed, fault-tolerance, resiliency, efficiency and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page representations. Such a representation may take the form of a markup language, such as the hypertext markup language (HTML), the extensible markup language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JavaScript, and so on. Computer program code written in these languages may facilitate the providing of web pages to client devices, as well as client device interaction with the web pages.

Server devices 202 can be used to store and distribute data between computing devices performing operations disclosed herein. For instance, multiple robotic devices can share sensor data captured measuring various tires with server devices 202. In turn, server devices 202 can perform extensive computations to detect different trends that can be used to optimize tire maintenance techniques performed by the robotic devices.

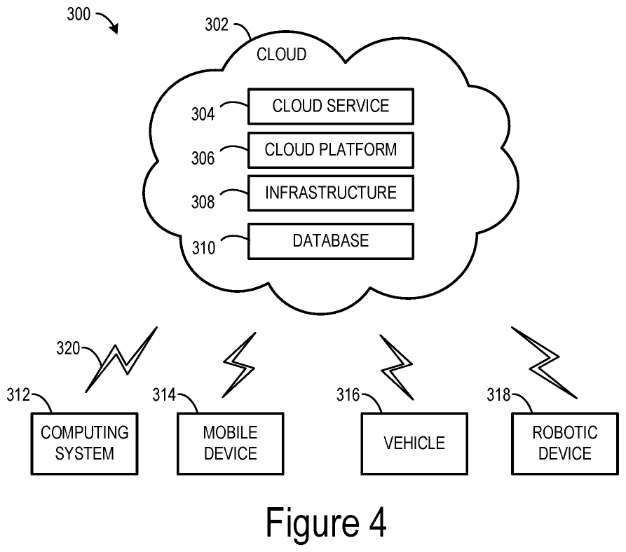

FIG. 4 is a system for cloud-based computing and communication, according to one or more example embodiments. Cloud system 300 includes cloud 302 having cloud service 304, cloud platform 306, cloud infrastructure 308, and database 310. In addition, cloud system 300 also includes computing system 312, mobile device 314, vehicle 316, and robotic device 318 communicating with cloud 302. In other embodiments, cloud system 300 may include more or less components, including other entities communicating with cloud 302.

Cloud-based computing generally refers to networked computer architectures in which application execution and storage may be divided, to some extent, between client and server devices. As such, a “cloud” may refer to a service or a group of services accessible over a network (e.g., Internet) by client (e.g., robotic devices) and server devices, for example.

Cloud 302 may include more or fewer components, and each of cloud service 304, cloud platform 306, the cloud infrastructure 308, and the database 310 may comprise multiple elements as well. Thus, one or more of the described functions of cloud system 300 may be divided into additional functional or physical components, or combined into fewer functional or physical components. Delivery of cloud computing may involve multiple cloud components communicating with each other over application programming interfaces, such as web services and three-tier architectures, for example.

Cloud 302 may represent networking computer architecture, and in one example, the cloud service 304 represents a queue for handling requests from client devices. Cloud platform 306 may include a front-end of the cloud and may be coupled to cloud service 304 to perform functions to interact with client devices. Cloud platform 306 may include applications used to access the cloud 302 via a user interface, such as a web browser. Cloud infrastructure 308 may include service application of billing components of cloud 302, and thus, may interact with cloud service 304. Database 310 may represent storage capabilities by cloud 302, and thus, may be accessed by any of cloud service 304, cloud platform 306, and/or cloud infrastructure 308.

Cloud system 300 includes a number of client devices coupled to or configured to be capable of communicating with components of cloud 302. For example, computing system 312, mobile device 314, vehicle 316, and robotic device 318 are shown communicatively coupled to cloud 302. Of course, more or fewer client devices may be coupled to cloud 302. In addition, different types of client devices may be coupled to cloud 302. For example, any of the client devices may generally comprise a display system, memory, and a processor.

Computing system 312 may be any type of computing device (e.g., PC, laptop computer, tablet, etc.), and mobile device 314 may be any type of mobile computing device (e.g., laptop, mobile telephone, cellular telephone, wearable device, etc.). In some examples, computing system 312 is a vehicle scan tool configured to read PIDs from vehicles. Other types of computing devices may communicate with cloud 302.

Vehicle 316 may be any type of vehicle with a transmitter/receiver that is configured to transmit/receive data to/from cloud 302. For instance, vehicle 316 may include a computing system and/or sensors that can communicate with cloud 302, computing system 312, mobile device 314, and robotic device 318. Vehicle 316 may include one or multiple tires that can be analyzed by the robotic device 318. The computing system 312, the mobile device 314, and/or the robotic device 318 can communicate with the vehicle 316 to obtain PID values identifying the year, make, model (YMM) of the vehicle and tire pressure measurements. The PID value and/or other communication with the vehicle 316 can enable the computing system 312, the mobile device 314, and/or the robotic device 318 to obtain a vehicle make identifier and a vehicle model identifier from the vehicle 316.

Robotic device 318 may include any computing device that has connection abilities to cloud 302 and actuation capability (e.g., electromechanical capabilities). A robotic device may further be a combination of computing devices in some applications. In some examples, robot device 318 may provide sensor data (e.g., vehicle 316 and corresponding tire information) and upload the data to cloud 302. Cloud 302 may be configured to perform calculations or analysis on the data and return processed data to robotic device 318. Similarly, cloud 302 can be used to store and analyze sensor data to detect trends and other useful determinations that can be subsequently applied by robotic device 318.

Any of the client devices may include additional components. For example, the robot device 318 may include one or more sensors and mechanical manipulators. Example sensors may include any of a gyroscope, accelerometer, Global Positioning System (GPS) receivers, infrared sensors, sonar, optical sensors, biosensors, Radio Frequency identification (RFID) systems, Near Field Communication (NFC) chip, wireless sensors, and/or compasses, among others, for example. These various sensors can be used to obtain data related to operations disclosed herein, including sensor data depicting vehicle treads and condition as well as location data for robotic device 318.

In addition, any of the client devices may include an integrated user-interface (UI) that allows a user to interact with the device. For example, robotic device 318 may include various buttons and/or a touchscreen interface that allow a user to provide input. As another example, the robotic device 318 may include a microphone configured to receive voice commands from a user. Furthermore, robotic device 118 may include one or more interfaces that allow various types of user-interface devices to be connected to robotic device 318.

Communication links between client devices (e.g., robot device 318) and cloud 302 may include wired connections, such as a serial or parallel bus. Communication links may also be wireless links, such as link 320, which may include BLUETOOTH®, IEEE 802.11 (IEEE 802.11 may refer to IEEE 802.11-2007, IEEE 802.11n-2009, or any other IEEE 802.11 revision), or other wireless based communication links.

In other examples, cloud system 300 may include access points through which the client devices may communicate with cloud 302. Access points may take various forms, for example, an access point may take the form of a wireless access point (WAP) or wireless router. As another example, if a client device connects using a cellular air-interface protocol, such as a CDMA or GSM protocol, an access point may be a base station in a cellular network that provides Internet connectivity via the cellular network.

As such, the client devices may include a wired or wireless network interface through which the client devices can connect to cloud 302 (or access points). As an example, the client devices may be configured use one or more protocols such as 802.11, 802.16 (WiMAX), LTE, GSM, GPRS, CDMA, EV-DO, and/or HSPDA, among others. Furthermore, the client devices may be configured to use multiple wired and/or wireless protocols, such as “3G”, “4G”, or “5G” data connectivity using a cellular communication protocol (e.g., CDMA, GSM, or WiMAX, as well as for “WI-FI®” connectivity using 802.11). Other examples are also possible.

### III. Example Robotic Device

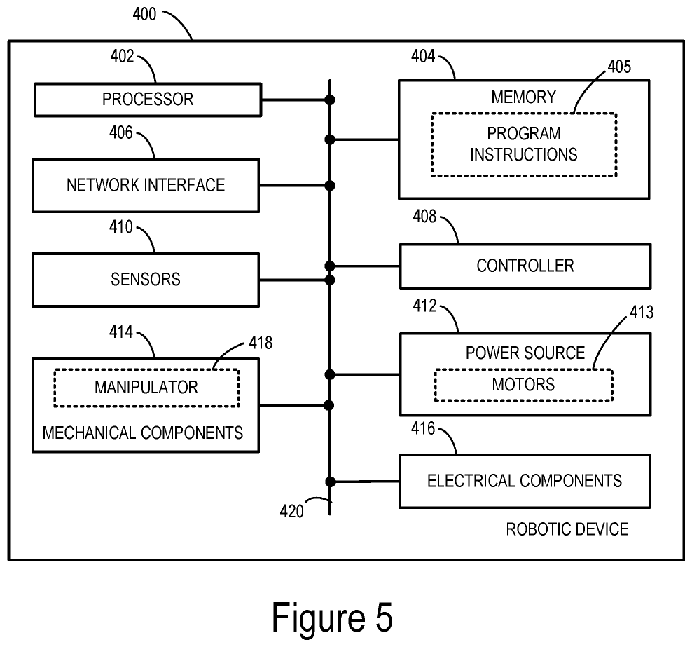

FIG. 5 is a block diagram representing a robotic device, according to one or more example embodiments. In the embodiment shown in FIG. 5, robotic device 400 includes processor 402, memory 404, network interface 406, controller 408, sensors 410, power source 412, mechanical components 414, and electrical components 416. In other embodiments, robotic device 400 may include more or fewer components.

Robotic device 400 may perform vehicle tire analysis and evaluation techniques as well as other operations described herein. As such, robotic device 400 may be configured to operate autonomously, semi-autonomously, and/or based on controls from a user received via various interfaces. For instance, robotic device 400 can be configured to perform particular operations autonomously related to measuring and evaluating vehicle tires.

In addition, robotic device 400 may have various forms within example embodiments. For instance, robotic device 400 may use legs, wheels, and/or other components for locomotion. Robotic device 400 can also be stationary in other examples. The various components of robotic device 400 may be connected in any manner, including wired or wireless connections, etc. For instance, connection 420 may enable components within robotic device 400 to interact. Further, in some examples, components of robotic device 400 may be positioned on multiple entities rather on a single entity. Other example illustrations of robotic device 400 may exist as well.

Processor 402 may include one or more processors similar to processor 102 implemented as part of computing system 100 illustrated in FIG. 2. Similarly, memory 404 and network interface 406 may operate similar to memory 104 and network interface 106 implemented as part of computing system 100. As shown in the example embodiment, memory 404 includes program instructions 405, which may enable robotic device 400 to perform operations disclosed herein.

Controller 408 may represent one or more components that enable control of robotic device 400. In some embodiments, controller 408 is positioned remotely from robotic device 400 and can enable a user to provide controls to robotic device 400.

Robotic device 400 further includes sensors 410, which may include a variety of sensors. Example sensors include, but are not limited to position sensors, force sensors, proximity sensors, load sensors, motion sensors, touch sensors, inertial measurement unit, global positioning system (GPS), infrared sensors, radar, and LIDAR. Sensors 410 may capture and provide sensor data to processor 402 to enable robotic device 400 to interact within an environment and perform operations. Controller 408 or another computing device may use sensor data from sensors 410 to determine control instructions for robotic device. In addition, sensors 410 may be used to enable use and evaluate performance of mechanical components 414 and electrical components 416. Sensors 410 may also enable robotic device 400 to measure aspects of the environment, including location of objects, temperatures, distances, size of lug nuts, an applied torque, a longitudinal axis of a wheel lug, and other possible information.

In some examples, sensors may include cameras configured to capture images of exterior surfaces of a vehicle tire and corresponding wheel. For instance, a sensor can be used to read a DOT tire identification number in order to identify the tire and correlate measurements with the tire. In some cases, a sensor may be used to obtain other information about a tire, such as the maximum cold inflation pressure. A sensor can also be used to measure a tire temperature, which can be compared to ambient temperature to determine whether the tire is cold or not.

Power source 412 can represent one or more power sources configured to power the robotic device 400. For example, robotic device 400 may include a hydraulic system, a pneumatic system, electrical system, one or more batteries, a gasoline engine, and/or other types of power systems. In addition, power source 412 may charge using various types of charging technology. For instance, power source 412 may use a wired connection to an outside power source or wireless charging in some examples.

In the example embodiment, power source 412 includes motors 413 configured to cause or impart motion. Motors 413 can include one or multiple electric motors configured to convert electrical energy into mechanical energy. The electric motors can be powered by direct current (DC) sources (e.g., batteries) or by alternating current (AC) sources, such as electrical generators, a power grid, or inverter. The electric motors can be brushed or brushless, single-phase, two-phase, or three-phase, axial or radial flux, and may be air-cooled or liquid-cooled. In addition, an electric motor may produce linear or rotary force that can propel one or multiple mechanical components 414, such as one or multiple manipulators 418.

Mechanical components 414 represent different manipulators and other hardware that may allow robotic device 400 to perform physical operations. For instance, robotic device 400 may include one or more actuators, legs, arms, and/or wheels. In some embodiments, mechanical components 414 may depend on the design of robotic device 400 and may also be based on the tasks the robotic device 400 is configured to perform. In addition, robotic device 400 may be configured to add and/or remove some mechanical components. The addition and subtraction process may be implemented by a user and/or another robotic device in some examples.

In at least some implementations, the mechanical components 414 includes wheel removal and replacement components (i.e., wheel R&R components) for removing a wheel from a vehicle and for reinstalling the wheel on the vehicle. As an example, the wheel R&R components can include wheel holder arms that are movable into contact with the treads of a tire at multiple different locations around the perimeter of the tire. For instance, the wheel holder arms can include four hold arms spaced apart by 90 degrees around an imaginary circle formed by the wheel holder arms. The wheel holder arms can be attached to a movable robotic arm by one or more flanges. The robotic arm, flange(s), and wheel holder arms can be selected to be able to withstand forces applied by the tire contacting the wheel holder arms.

As another example, the wheel R&R components can include a socket driver (e.g., a hydraulic socket driver) and a set of multiple sockets. The processor 402 can use an input provided by the sensors 410 to determine a size of the lug nuts retaining a wheel to the vehicle and a corresponding size socket. The processor 402 can direct movement of the socket driver to the set of sockets and attach the socket driver to the corresponding size socket. The sensors 410 can include one or more sensors to output signals indicative of an amount of torque being applied by the socket driver to a lug nut. The processor 402 can control the socket driver to tighten the lug nuts on a lug of the vehicle until the amount of torque based on the output signals of the sensors 410 reaches a specified torque value for the lug nuts and particular vehicle to which the wheel is being attached.

As yet another example, the wheel R&R components can include a lug nut holder to store a lug nut after being removed from a lug by the socket driver and until retrieved by the socket driver for reattachment of the wheel to the vehicle. The processor 402 can use signals from the sensors 410 to determine an axis of a wheel lug so that the socket driver can be aligned such that a longitudinal axis of the socket attached to the socket driver is coaxial with the longitudinal axis of the wheel lug. This alignment can reduce and/or eliminate the amount of times the robotic device 400 cross-threads a lug nut onto a wheel lug.

As yet another example, the wheel R&R components can include a dispenser for dispensing a penetrating oil onto a wheel lug and lug nut. The sensors 410 can output signals indicative of a location of the wheel lug and lug nut so that the dispenser can be positioned at an appropriate position for dispensing the penetrating oil.

Manipulator 418 represents a particular mechanical component that robotic device 400 may utilize to perform one or more specific tasks, such as operations related to automatic vehicle tire measurement and analysis described herein. The configuration, shape, and size of manipulator 418 can vary within examples. In addition, robotic device 400 may include multiple manipulators 418 with the same or different configurations. In some examples, robotic device 400 may be configured to switch manipulators physically.

In some examples, the robotic device 400 may include a rolling manipulator that can cause the rotation of the vehicle tire. The rolling manipulator may be a cylindrical roller that can rotate proximate to a portion of the tire thereby causing the tire to rotate. The rolling manipulator can include or be coupled to one or multiple motors 413. For instance, an electric motor coupled to the rolling motor can also be operatively coupled to an electrical power system positioned on the robotic device 400. The motors 413 can enable rotation of the rolling manipulator in both directions and at various speeds.

In some examples, the robotic device 400 may include a wheel balancer designed to rotate the vehicle tire. For instance, the wheel balancer can connect to one or multiple motors 413 and cause the vehicle tire to rotate.

Electrical components 416 may represent various components configured to process, transfer, provide electrical charge or electric signals, for example. For instance, electrical components 416 may include electrical wires, circuitry, communication transmitters and receivers to enable operations of the robotic device 400. As such, electrical components 416 may interwork with mechanical components 414 to perform various functions. As another example, the electrical components 416 can include a light source for illuminating a tire. Electrical components 416 may be configured to provide power from power source 412 to the various mechanical components 414.

### IV. Example Artificial Neural Network

An artificial neural network (ANN) is a computational model in which a number of simple units, working individually in parallel and without central control, can combine to solve complex problems. An ANN can be represented as a number of nodes that are arranged into a number of layers. There are connections between the nodes of adjacent layers. Disclosed models can be trained to perform tire measuring operations described herein.

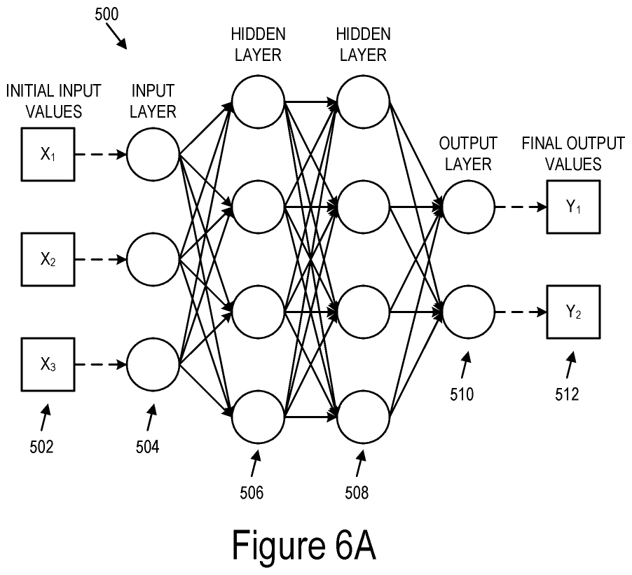

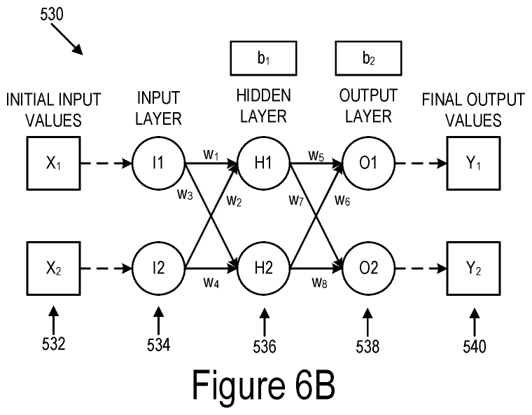

FIG. 6A illustrates an ANN 500, which represents a feed-forward multilayer neural network. ANN 500 can be generated and/or located onboard a computing device (e.g., computing system 100 shown in FIG. 2), at a server (e.g., server devices 202 shown in FIG. 3), on a robotic device (e.g., robotic device 318 shown in FIG. 3 or robotic device 400 shown in FIG. 4). In addition, ANN 500 can be generated by one computing system (e.g., a server) and deployed for use by another computing system (e.g., robotic device 400 shown in FIG. 4). Similar structures and principles can be used in convolution neural networks (CNNs), recurrent neural networks, and recursive neural networks, for example. ANN 500 can be trained to perform particular tasks, such as image processing techniques (e.g., segmentation, semantic segmentation, image enhancements), computer vision techniques, tire detection and analysis, or learning other robotic control functions described herein. For instance, image processing and computer visions techniques can be used by a robotic device when analyzing tires. Similarly, models can be trained based on data measured from multiple tires.

In some examples, ANN 500 can be used to detect trends within tires analyzed by one or more robotic devices. For instance, ANN 500 may use images from robotic cameras and/or other sensor data to learn to detect differences between functional tires and tires that require some type of repair or replacement. By analyzing large amounts of robotic sensor data, ANN 500 can increase the abilities of robotic devices to identify issues during tire servicing. ANN 500 can be trained via specifications and tire data from numerous tires. The data can be obtained via sensors, which may be used by technicians and/or robotic devices. In some examples, a vehicle make identifier and a vehicle model identifier may be provided to ANN 500, which can provide control instructions based on a vehicle's make and model.

In the embodiment shown in FIG. 6A, ANN 500 consists of four layers: input layer 504, hidden layer 506, hidden layer 508, and output layer 510. The three nodes of input layer 504 respectively receive X₁, X₂, and X₃ as initial input values 502 and the two nodes of output layer 510 respectively produce Y₁ and Y₂ as final output values 512. As a fully-connected network, nodes of each layer aside from input layer 504 may be configured to receive input from all nodes in the previous layer within ANN 500.

As further shown in FIG. 6A, the solid arrows between pairs of nodes represent connections through which intermediate values flow. Each solid arrow is associated with a respective weight that can be applied to the respective intermediate value. Each node can perform an operation on its input values and associated weights (e.g., values between 0 and 1, inclusive) to produce an output value. In some cases, the operation performed by a node may involve a dot-product sum of the products of each input value and associated weight. In addition, an activation function may be applied to the result of the dot-product sum to produce the output value. Other operations are possible.

As an example, if a node receives input values {x₁, x₂, . . . , xₙ} on n connections with respective weights of {w₁, w₂, . . . , wₙ}, the dot-product sum d may be determined as:

$$d = {\sum }_{i = 1}^{n} {x}_{i} {w}_{i} + b \qquad ( 1 )$$

where b is a node-specific or layer-specific bias.

In some examples, the fully-connected nature of ANN 500 may be used to effectively represent a partially-connected ANN by giving one or more weights a value of 0. Similarly, the bias can also be set to 0 to eliminate the b term shown in equation (1) above. In addition, an activation function (e.g., the logistic function) may be used to map d to an output value y that is between 0 and 1, inclusive:

$$y = \frac{1}{1 + {e}^{- d}} \qquad ( 2 )$$

Functions other than the logistic function, such as the sigmoid or tan h functions, may be used instead. Then, y may be used on each output connection of the node and can be modified by the respective weights thereof. In ANN 500, the input values and weights are applied to the nodes of each layer, from left to right until final output values 512 are produced. If ANN 500 has been fully trained, final output values 512 can a proposed solution to the problem that ANN 500 has been trained to solve. As such, training the ANN 500 can produce a meaningful, useful, and reasonably accurate solution.

### B. Training

Training the ANN 500 or another ANN may involve providing some form of supervisory training data, such as tire data acquired for numerous types of tires. The tire data can be labeled or unlabeled. In particular, supervisory training data may include sets of input values and desired output values (i.e., ground truth). For example, supervisory training data that can be used to enable an ANN to perform image processing tasks may involve pairs of images that include a training image and a corresponding ground truth mask that represents a desired output (e.g., desired segmentation) of the training image. As an example, sensor data pairs corresponding to various vehicle tires can be provided as training data. Each sensor data pair can include raw sensor data depicting the vehicle tire and labeled sensor data that identifies any flaws in the same vehicle tire. In another example, images and/or other type of sensor data representing a used vehicle tire can be input along with images and/or the other type of sensor data representing a new vehicle tire of the same brand and type can be input as training data for ANN 500.

For ANN 500, the training data may include m sets of input values paired with output values, which can be represented as:

$$\{ {X}_{1 , i} , {X}_{2 , i} , {X}_{3 , i} , , \} \qquad ( 3 )$$

where i=1 . . . m, and [symbol] and [symbol] are the desired output values for the input values of X_{1,i}, X_{2,i}, and X_{3,i}.

An example training process can involve applying the input values from such a set to ANN 500 and producing associated output values. As such, a loss function can be used to evaluate the error between the produced output values and the ground truth output values. In some instances, the loss function may be a sum of differences, mean squared error, or some other metric. Error values can be determined for all of the m sets, and the error function involves calculating an aggregate (e.g., an average) of these values.

In some instance, after the error function is determined, the weights on the connections can updated to attempt to reduce the error. In simple terms, the update process may involve rewarding “good” weights and penalizing “bad” weights. Thus, the updating may distribute the causes for the error through ANN 500 in a way that can decrease the error for future iterations of the training data. For example, the update process can involve modifying one or more weights of ANN 500 to cause subsequent applications of ANN 500 on training images to generate new outputs that more closely match the ground truth masks that correspond to the training images.

The training process can involve further applying the training data to ANN 500 until the weights converge. In some examples, convergence occurs when the error is less than a threshold value or the change in the error is sufficiently small between consecutive iterations of training. At this point, ANN 500 is said to be “trained” and can be applied to new sets of input values in order to predict output values that are unknown based on the input values. For example, ANN 500 may produce outputs of input images that closely resemble ground truths (i.e., desired results) created for the input images after ANN 500 is trained to perform an image processing technique. Sensor data obtained for a vehicle tire can be input ANN 500 in order for ANN 500 to output diagnostic information that resemble ground truths provided during training.

Many training techniques for ANNs may use some form of backpropagation, which can involve input signals being forward-propagated through the network towards the outputs. Network errors can then calculated with respect to target variables and back-propagated backwards towards the inputs. As such, backpropagation can distribute the error one layer at a time, from right to left, through ANN 500. As a result, the weights of the connections between hidden layer 508 and output layer 510 are updated first, the weights of the connections between hidden layer 506 and hidden layer 508 are updated second, and so on. The updating applied can be based on the derivative of the activation function.

In order to further explain error determination and backpropagation, an example of the process is further described herein. However, backpropagation can become quite complex to represent except on the simplest of ANNs. Thus, to avoid too much complexity, FIG. 6B illustrates a simple ANN 530 in order to provide an example of backpropagation. Similar to ANN 500, ANN 530 can be generated by a computing system, a set of computing devices, a server, and/or a robotic device and can be deployed for operation on various types of computing systems and/or robotic devices.

TABLE 1

| Weight | Nodes |
|---|---|
| w₁ | I1, H1 |
| w₂ | I2, H1 |
| w₃ | I1, H2 |
| w₄ | I2, H2 |
| w₅ | H1, O1 |
| w₆ | H2, O1 |
| w₇ | H1, O2 |
| w₈ | H2, O2 |

In the embodiment depicted in FIG. 6B, ANN 530 includes three layers, input layer 534, hidden layer 536, and output layer 538. Each of these layers are shown having two nodes. Initial input values 532 are provided to input layer 534, and output layer 538 are configured to produce final output values 540. Weights have been assigned to each of the connections and biases (e.g., b₁, b₂ shown in FIG. 6B) may also apply to the net input of each node in hidden layer 536 in some examples. To further illustrate, Table 1 maps weights to pair of nodes with connections to which these weights apply. For example, w₂ is applied to the connection between nodes 12 and H1, w₇ is applied to the connection between nodes H1 and O2, and so on.

Training ANN 530 can update the weights over some number of feed forward and backpropagation iterations until final output values 540 are sufficiently close to designated desired outputs. As such, the use of a single set of training data effectively trains ANN 530 for just that set. When multiple sets of training data are used, ANN 530 is also trained in accordance with those sets as well.

### 1. Example Feed Forward Pass

To initiate the feed forward pass, net inputs to each of the nodes in hidden layer 336 are calculated. From the net inputs, the outputs of these nodes can be found by applying the activation function. For node H1, the net input net_{H1} is:

$$n e {t}_{H 1} = {w}_{1} {X}_{1} + {w}_{2} {X}_{2} + {b}_{1} \qquad ( 4 )$$

Applying the activation function (here, the logistic function) to this input determines that the output of node H1, out_{H1} is:

$${out}_{H 1} = \frac{1}{1 + {e}^{- n {et}_{H 1}}} \qquad ( 5 )$$

Following the same procedure for node H2, the output out_{H2} can also be determined. The next step in the feed forward iteration is to perform the same calculations for the nodes of output layer 538. For example, net input to node O1, net_{O1} is:

$${net}_{O 1} = {w}_{5} {out}_{H 1} + {w}_{6} {out}_{H 2} + {b}_{2} \qquad ( 6 )$$

Thus, output for node O1, out_{O1} is:

$${out}_{O 1} = \frac{1}{1 + {e}^{- n {et}_{O 1}}} \qquad ( 7 )$$

Following the same procedure for node O2, the output out_{O2} can be determined. At this point, the total error, Δ, can be determined based on a loss function. For instance, the loss function can be the sum of the squared error for the nodes in output layer 510. In other words:

$$Δ = {Δ}_{O 1} + {Δ}_{O 2} = \frac{1}{2} {( {out}_{O 1} - {\hat{Y}}_{1} )}^{2} + \frac{1}{2} {( {out}_{O 2} - \hat{{Y}_{2}} )}^{2} \qquad ( 8 )$$

The multiplicative constant ½ in each term is used to simplify differentiation during backpropagation. Since the overall result is scaled by a learning rate anyway, this constant does not negatively impact the training. Regardless, at this point, the feed forward iteration completes and backpropagation begins.

### 2. Backpropagation

As noted above, a goal of backpropagation is to use Δ (i.e., the total error determined based on a loss function) to update the weights so that they contribute less error in future feed forward iterations. As an example, consider the weight w₅. The goal involves determining how much the change in w₅ affects Δ. This can be expressed as the partial derivative

$$\frac{\partial Δ}{\partial {w}_{5}} .$$

Using the chain rule, this term can be expanded as:

$$\frac{\partial Δ}{\partial {w}_{5}} = \frac{\partial Δ}{\partial {out}_{O 1}} \times \frac{\partial {out}_{O 1}}{\partial {net}_{O 1}} \times \frac{\partial {net}_{O 1}}{\partial {w}_{5}} \qquad ( 9 )$$

Thus, the effect on Δ of change to w₅ is equivalent to the product of (i) the effect on Δ of change to out_{O1}, (ii) the effect on out_{O1} of change to net_{O1}, and (iii) the effect on net_{O1} of change to w₅. Each of these multiplicative terms can be determined independently. Intuitively, this process can be thought of as isolating the impact of w₅ on net_{O1}, the impact of net_{O1} on out_{O1}, and the impact of out_{O1} on Δ.

This process can be repeated for the other weights feeding into output layer 338. Note that no weights are updated until the updates to all weights have been determined at the end of backpropagation. Then, all weights are updated before the next feed forward iteration.

After updates to the remaining weights, w₁, w₂, w₃, and w₄ are calculated, backpropagation pass is continued to hidden layer 536. This process can be repeated for the other weights feeding into output layer 538. At this point, the backpropagation iteration is over, and all weights have been updated. ANN 530 may continue to be trained through subsequent feed forward and backpropagation iterations. In some instances, after over several feed forward and backpropagation iterations (e.g., thousands of iterations), the error can be reduced to produce results proximate the original desired results. At that point, the values of Y₁ and Y₂ will be close to the target values. As shown, by using a differentiable loss function, the total error of predictions output by ANN 530 compared to desired results can be determined and used to modify weights of ANN 530 accordingly.

In some cases, an equivalent amount of training can be accomplished with fewer iterations if the hyper parameters of the system (e.g., the biases b₁ and b₂ and the learning rate a) are adjusted. For instance, the setting the learning rate closer to a particular value may result in the error rate being reduced more rapidly. Additionally, the biases can be updated as part of the learning process in a similar fashion to how the weights are updated. Regardless, ANN 500 is just a simplified example. Arbitrarily complex ANNs can be developed with the number of nodes in each of the input and output layers tuned to address specific problems or goals, such as analyzing tires. Further, more than one hidden layer can be used and any number of nodes can be in each hidden layer. In some examples, sensor measurements corresponding to a tire can be provided as inputs to ANN 500. ANN 500 may use the sensor inputs to output parameters that indicate a condition of the tire. For instance, ANN 500 may output one or multiple scores that represent conditions of different aspects of the tire. One or more robotic devices can obtain and provide sensor measurements of a vehicle tire as inputs to ANN 500.

### V. Example Method for Automatic Vehicle Tire Condition Analysis

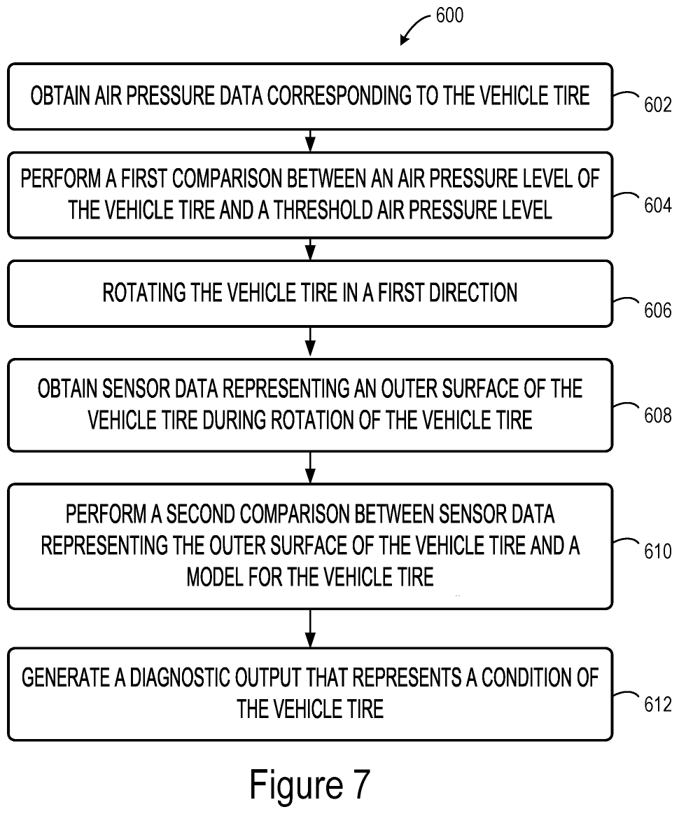

FIG. 7 is a flow chart of a method for automatic analysis of the condition of a tire, according to one or more example embodiments. Method 600 may include one or more operations, functions, or actions as illustrated by one or more of blocks 602, 604, 606, 608, 610, and 612. Although the blocks are illustrated in a sequential order, these blocks may in some instances be performed in parallel, and/or in a different order than those described herein. Also, the various blocks may be combined into fewer blocks, divided into additional blocks, and/or removed based upon the desired implementation.

In addition, for method 600 and other processes and methods disclosed herein, the flowchart shows functionality and operation of one possible implementation of present embodiments. In this regard, each block may represent a module, a segment, or a portion of program code, which includes one or more instructions executable by a processor for implementing specific logical functions or steps in the process. The program code may be stored on any type of computer readable medium or memory, for example, such as a storage device including a disk or hard drive.

The computer readable medium may include a non-transitory computer readable medium, for example, such as computer-readable media that stores data for short periods of time like register memory, processor cache and Random Access Memory (RAM). The computer readable medium may also include non-transitory media or memory, such as secondary or persistent long term storage, like read only memory (ROM), optical or magnetic disks, compact-disc read only memory (CD-ROM), for example.

The computer readable media may also be any other volatile or non-volatile storage systems. The computer readable medium may be considered a computer readable storage medium, a tangible storage device, or other article of manufacture, for example. Furthermore, for method 600 and other processes and methods disclosed herein, each block in FIG. 7 may represent circuitry that is wired to perform the specific logical functions in the process or at least a portion of the specific logical functions.

At block 602, method 600 involves obtaining air pressure data corresponding to the vehicle tire. A robotic device may obtain the air pressure data from a first sensor, such as an air pressure sensor or an air pressure gauge. In some cases, the robotic device may include a communication interface that enables wired or wireless communication with the first sensor positioned to measure the air pressure level of the vehicle tire. For instance, a technician or the owner of the vehicle may connect the first sensor onto the fill valve of the vehicle tire to obtain air pressure measurements. In some examples, the first sensor can be positioned on the robotic device and the robotic device may couple the first sensor to the valve stem of the tire.

In some examples, the robotic device may obtain air pressure data based on PIDs. For instance, the robotic device may connect and receive PID data directly from the vehicle (e.g., from an electronic control unit (ECU) of the vehicle), which may be generated based on measurements by a TPMS. As an example, the robotic device may obtain air pressure measurements for all of the tires located on the vehicle. In other examples, the robotic device may receive the air pressure data from another computing device. The robotic device can activate one or more sensors to read PSI and other TPMS data. In some instances, the robotic device may communicate with one or more sensors to obtain PSI and other TPMS data. For instance, the robotic device may communicate with the ECU of a vehicle or sensors individually. In some cases, the robotic device may use a magnet to activate the TPMS sensor or rotate the wheel. In some examples, the robotic device may use the make and year of the vehicle to identify and transmit the correct low frequency wake up signal to the TPMS sensor and subsequently receive measurements from the sensor. The robotic device may also obtain temperature, battery condition, and other data via a similar technique.

In some examples, the robotic device may also determine a tire type corresponding to the vehicle tire. In some embodiments, the tire type is based on multiple parameters, such as a brand for the vehicle tire, an estimated distance that the vehicle tire has traveled on the vehicle, and the air pressure level of the tire. The tire type can depend on prior usage, such as the number of miles that the vehicle tire has been used, which can be determined based on visual analysis of treads, PID data, input by a user, or via another technique. The tire type can also depend on the type of vehicle using the tire. For instance, the weight and ride height of the vehicle may be factored when determining the tire type.

In general, the tire type may convey additional information about the vehicle tire. In some examples, the robotic device may then obtain one or more threshold air pressure levels and other information based on the tire type, such as a model for the vehicle tire. For instance, the robotic device may use computer vision and images from a camera to determine information about the tire, such as a model number. In other examples, the robotic device may obtain the information about the tire from another source, such as input by a user or technician through an interface of the robotic device and/or another computing device.

In some examples, the robotic device may check the temperature of the tire, which may provide information related to recent use of the vehicle using the tire. When a vehicle is driven at high speeds just prior to evaluation, the air pressure may differ due to the temperature of the tire. As such, the robotic device may factor the tire's temperature when analyzing the air pressure and other aspects of the tire.

At block 604, method 600 involves performing a first comparison between an air pressure level of the vehicle tire and a threshold air pressure level. The robotic device may determine the vehicle tire's air pressure level based on the air pressure data. In practice, the sensor measurements may indicate the air pressure level of the tire. For instance, the sensor data may indicate that the tire contains 33 pounds per square inch (PSI) of air. The robotic device may compare the measured 33 PSI for the tire with one or multiple air pressure values, which may include a lower bound air pressure value and an upper bound air pressure value in some examples. For instance, the robotic device may determine that the measured 33 PSI within the tire is above a 31 PSI lower bound value and below a 36 PSI upper bound value.

The robotic device may initially evaluate the tire's air pressure to determine subsequent operations. In some cases, the robotic device may use the comparison results to provide an alert to a user or a technician when the measured PSI warrants review. The robotic device may also reposition the tire or connect an air pump (e.g., an air compressor) to the tire in some examples. For instance, the robotic device may fill the tire with air via an air pump to a desired pressure level based on the tire type and/or other parameters. As an example, when the local weather conditions are colder, the robotic device may use a higher threshold air pressure level based on the colder weather conditions. In some cases, the robotic device may also adjust the air pressure level of the tire based on the condition (e.g., add air given the cold weather conditions).

In some embodiments, the first comparison may involve comparing the air pressure level of the vehicle tire relative to multiple air pressure levels, which can be used to determine how to further evaluate the vehicle tire. In particular, the robotic device may continue to analyze the vehicle tire's condition relative to baselines that depend on the air pressure level of the vehicle tire. In some cases, the robotic device may also add or remove air pressure from the vehicle tire prior to further analysis. The robotic device may use pressure and temperature measurements from one or more sensors, which can allow the robotic device to detect potential issues, such as over-inflation, under-inflation, or uneven wear.

At block 606, method 600 involves rotating the vehicle tire in a first direction. The robotic device may use a mechanical manipulator to rotate the vehicle tire in the first direction. In some instances, the robotic device may initiate rotation of the tire responsive to the air pressure level of the tire exceeding the threshold air pressure level. For instance, the robotic device may initiate rotation in response to determining that the air pressure within the tire is at a desired level or within a desired range for the tire type.

The mechanical manipulator can differ within examples. In some examples, the robotic device may use a rolling manipulator to rotate the vehicle tire. In other examples, the robotic device may use a wheel balance to rotate the vehicle tire. In further examples, the robotic device may use a combination of mechanical manipulators to rotate the vehicle tire. For instance, the robotic device can connect a mechanical manipulator via a suction technique or a gripper to a center portion of the tire and initiate rotation in response.

In some examples, the robotic device may detect a position of the vehicle tire using a camera and, responsive to detecting the position of the vehicle tire using the camera, couple the mechanical manipulator to the vehicle tire based on the position of the vehicle tire. The robotic device may then rotate the vehicle tire in the first direction responsive to coupling the mechanical manipulator to the vehicle tire. In some examples, a technician or an owner may position a vehicle in a manner such that a portion of the tire engages the mechanical manipulator of the robotic device. For instance, the bottom of the tire can be positioned on top of a roller that can rotate the vehicle tire.

At block 608, method 600 involves obtaining sensor data representing an outer surface of the vehicle tire during rotation of the vehicle tire. The robotic device may obtain the sensor data from a second sensor. For instance, the robotic device may capture images of the outer surface (e.g., a tread wall and/or side wall(s)) of the vehicle tire using a camera.

Sensor data can be obtained at one or multiple rotation speeds. As such, the robotic device may associate sensor measurements of the vehicle tire with the particular speed of rotation used when capturing the sensor measurements, which enables similar comparisons to baselines that were captured at the particular speed of rotation as well. For instance, the robotic device may obtain sensor data while rotating the vehicle tire at a first speed and then obtain additional sensor data while rotating the vehicle tire at a second speed. The different sets of sensor data can be associated with the first and second speeds, respectively.

In some examples, the robotic device may receive depth measurements of the outer surface of the vehicle tire from a photo electronic sensor in some examples. The robotic device may determine a tread mapping of the outer surface of the vehicle tire based on the depth measurements. The tread mapping can be generated based sensor measurements captured during one or multiple rotations of the vehicle tire. A depth sensor may be used at the second sensor in some examples. In some embodiments, the robotic device may perform ultrasonic testing, which can involve using ultrasonic waves to inspect the tire's internal structure for any defects, such as separation, cords breakage, or irregular thickness.

At block 610, method 600 involves performing a second comparison between the sensor data representing the outer surface of the vehicle tire and a model for the vehicle tire. For instance, the robotic device may perform the second comparison between the images of the outer surface of the vehicle tire and a particular model for the vehicle tire. The particular model can be based on a plurality of images of a given vehicle tire based on a type of the vehicle tire.

In some examples, the robotic device may perform the second comparison between the tread mapping of the outer surface of the vehicle tire and a model tread mapping for the vehicle tire. The robotic device can then determine one or more differences based on the second comparison. For instance, the robotic device may determine an amount of wear corresponding to the vehicle tire based on the one or more differences. In some examples, the robotic device may estimate, based on the amount of wear, an amount of use left before the vehicle tire reaches a threshold tread limit. For instance, the estimation may indicate that the vehicle treads have 10 percent life left prior to falling under the legal tread limit. As such, the robotic device may generate the diagnostic output to represent the amount of use left before the vehicle tire reaches the threshold tread limit. As an example, the amount of use remaining can be specified as a quantity of mile or kilometers. As another example, the amount of use remaining can be specified as a quantity of time (e.g., a quantity of months) based on the quantity of miles or kilometers and an average use expected for the vehicle (e.g., an expected/average number of miles the vehicle is driven each month).

In some cases, the robotic device may use laser scanning to measure the tire's profile, tread patterns, and other dimensions to detect signs of irregular wear or other issues. The robotic device may also use load sensors or simulation software to apply various loads to the tire and evaluate its response, such as deformation or stability. The results can indicate issues, such as overloading or poor balance.

At block 612, method 600 involves generating a diagnostic output that represents a condition of the vehicle tire. The robotic device may generate the diagnostic output based on the second comparison. The condition of the vehicle tire can depend on the variation between measurements obtained from the vehicle tire and one or multiple baselines represented by a model or models used to evaluate the vehicle tire. For instance, the robotic device may generate the diagnostic output to include an indication of the amount of wear corresponding to the vehicle tire. In some examples, the diagnostic output may indicate that there is one or multiple punctures or depressions within the tire and/or other irregularities that may decrease the condition of the tire. As such, the output may specify a recommendation to change the tire or may include an estimation on how much life the tire has until another check and/or replacement is needed. The robotic device may use data from other tire evaluations when developing the recommendations and/or estimations on the remaining life of an evaluated tire. In addition, the robotic device can weight different factors when providing a description that articulates the vehicle tire's condition. For instance, detection of nails or other punctures or depressions in the tire may be weighted more than a bulge detected in the tire when evaluating the condition.

In some examples, the diagnostic output may further include a recommendation. The recommendation could be based on a quantity of defects detected and the results of the first comparison and the second comparison. The recommendation may indicate whether to replace the tire or not. In some cases, the diagnostic output can further include an estimation that predicts when the vehicle tire should be changed. For example, the robotic device may determine the estimated life remaining for the vehicle (e.g., how many more miles can the tire be safely used) based on an analysis of tread depth relative to one or more baselines, such as a legal limit for tread depth. In other cases, the recommendation may indicate that the tire can be repaired by use of a tire patch or plug. In addition, the robotic device may mark portions of the tire that may require some sort of further review or repair. For instance, the robotic device may use a marker, paint, laser, heat source, or another tool to mark portions of the tire when a defect or defects are detected.

In some examples, the robotic device may identify an irregularity in tread depth of the vehicle tire based on the second comparison and estimate a position of the irregularity in tread depth of the vehicle tire relative to a point on the vehicle tire (e.g., the valve stem). The robotic device may then generate the diagnostic output with an indication of the estimated position of the irregularity in tread depth of the vehicle tire. For example, the diagnostic output may include one or more images of the outer surface of the vehicle tire with the images depicting the one or more irregularities with visual marks representing the position for each irregularity relative to the valve stem of the vehicle tire. For instance, the visual marks can be boxes or another visual cue added by the robotic device to highlight the position of the irregularity in the images. In some examples, the robotic device may generate a visual representation of the vehicle tire comprising a reference point based on the estimated position of the irregularity in tread depth of the vehicle tire.

In some examples, the robotic device may detect a bulge in a side wall of the vehicle tire based on the second comparison and generate the diagnostic output with an indication of the bulge detected in the side wall of the vehicle tire. The robotic device can mark the irregularity on the vehicle tire using a marking (e.g., RFID tag) and/or mark the irregularity on a digital representation of the vehicle tire.

In some examples, the robotic device may receive, from a sensor coupled to the robotic device, sensor data representing a position of the vehicle tire relative to the robotic device. The robotic device may then provide the sensor data representing the position (e.g., distance and orientation) of the vehicle tire as an input to a neural network, such as the ANN 500, 530. For instance, the neural network can be trained to provide movement instructions for the mechanical manipulator based on the distance and orientation of the vehicle tire. As such, the robotic device may couple the mechanical manipulator to the vehicle tire based on control instructions output by the neural network. For instance, the output can specify movement instructions for the robotic device that enables the robotic device to move within a repair shop and avoid obstacles and people located therein. In some instances, the output generated by the neural network can provide control instructions for movement of a robotic manipulator or multiple robotic manipulators. In addition, the neural network can output instructions for movement of one or multiple sensors, which may be located on the robotic device or external to the robotic device. In other examples, the neural network can generate control instructions for movement of tools (e.g., socket driver), dispenser, and/or wheel holder arms, among other mechanical devices.

In some examples, the vehicle tire is coupled to a vehicle. The vehicle is associated with a vehicle make identifier and a vehicle model identifier. The robotic device may then provide an indication of the vehicle make identifier and the vehicle model identifier as a second input to the neural network. The neural network may be further trained to provide movement instructions for the mechanical manipulator based on the vehicle make identifier and the vehicle model identifier of the vehicle. For instance, a robotic device may use a model for control instructions that depends on the vehicle's make and model. As such, the vehicle make and the vehicle model identifiers can be used to identify the model that was generated for that vehicle. The models can provide instructions that vary based on the height of the vehicle, the size of the tire, and/or other parameters that can be determined based on the vehicle's make and model.

In some examples, the robotic device may illuminate at least a portion of the vehicle tire during rotation of the vehicle tire using a light. The light can be coupled to the robotic device. As such, the robotic device may obtain, from the second sensor, first sensor data indicative of light reflections reflecting off the outer surface of the vehicle tire and then adjust a level of illumination during rotation of the vehicle tire based on the first sensor data. Responsive to adjusting the level of illumination, the robotic device may obtain, from the second sensor, second sensor data indicative of light reflections reflecting off the outer surface of the vehicle tire (and off objects coupled on the outer surface of the vehicle tire). The robotic device can distinguish differences in the reflected light to determine whether the reflected light includes light reflected from the tire itself (e.g., a side wall or tread surface of the tire) or a material coupled to the tire, such as a nail or screw embedded in the tire. The robotic device can estimate a position for each reflective material coupled to the vehicle tire, the material detected based on the first sensor data and the second sensor data and generate the diagnostic output to convey the estimated position for each reflective material coupled to the vehicle tire.

In some examples, the robotic device may adjust a rotation speed of the vehicle tire using the mechanical manipulator during rotation of the vehicle tire. Based on adjusting the rotation speed of the vehicle tire, the robotic device may determine that the vehicle tire is out of balance.

In some examples, the robotic device may adjust the mechanical manipulator based on training data collected by an augmented reality device during past inspections of vehicle tires. In addition, the robotic device may also use an RFID tag and reader to identify information corresponding to the vehicle tire. For instance, the information may indicate the vehicle tire's type.

In some embodiments, the robotic device may use cameras and image processing algorithms to inspect the tire's tread depth, sidewall condition, and any visible damages, such as cuts, punctures, depressions, or bulges. The visual inspection can be used to mark issues directly on the tire and/or on a digital representation of the tire. The diagnostic output can then be generated based on the visual inspection.

In some embodiments, the robotic device may detect, based on the sensor data, a foreign object coupled to the vehicle tire and determine a position of the foreign object relative to a fill valve on the vehicle tire. The robotic device may then generate a visual representation of the vehicle tire comprising a reference point based on the position of the foreign object relative to the vehicle tire. Based on the second comparison, the robotic device may also detect a bulge in the vehicle tire and then cause the visual representation of the vehicle tire to further include a second reference point based on a position of the bulge in the vehicle tire.

In some embodiments, lasers can be used to measure the wobble of a tire by creating a precise reference line and using laser sensors to detect deviations from that line. The robotic can use one or more lasers to shine a laser beam onto the tire and measure the reflection with a photodiode or other light sensor. For instance, the laser and sensor can be mounted on a fixed platform associated with the robotic device, while the tire rotates underneath. The deviation of the laser reflection from the reference line is proportional to the wobble of the tire. By analyzing the signal from the light sensor, the robotic device can determine the amplitude and frequency of the wobble, which can indicate issues such as imbalance or bent rims. The robotic device can use the disclosed technique to obtain very precise and accurate measurements of tire wobble.

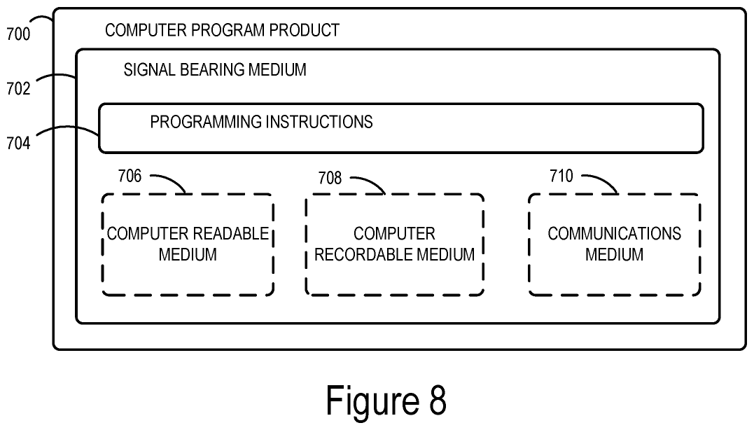

FIG. 8 is a schematic illustrating a conceptual partial view of a computer program for executing a computer process on a computing system, arranged according to at least some embodiments presented herein. In some embodiments, the disclosed methods may be implemented as computer program instructions encoded on a non-transitory computer-readable storage media in a machine-readable format, or on other non-transitory media or articles of manufacture.

In one embodiment, example computer program product 700 is provided using signal bearing medium 702, which may include one or more programming instructions 704 that, when executed by one or more processors may provide functionality or portions of the functionality described above with respect to FIGS. 1-7. In some examples, the signal bearing medium 702 may encompass a non-transitory computer-readable medium 706, such as, but not limited to, a hard disk drive, a Compact Disc (CD), a Digital Video Disk (DVD), a digital tape, memory, etc. In some implementations, the signal bearing medium 702 may encompass a computer recordable medium 708, such as, but not limited to, memory, read/write (R/W) CDs, R/W DVDs, etc. In some implementations, the signal bearing medium 702 may encompass a communications medium 710, such as, but not limited to, a digital and/or an analog communication medium (e.g., a fiber optic cable, a waveguide, a wired communications link, a wireless communication link, etc.). Thus, for example, the signal bearing medium 702 may be conveyed by a wireless form of the communications medium 710.

The one or more programming instructions 704 may be, for example, computer executable and/or logic implemented instructions. In some examples, a computing device such as the computer system 100 of FIG. 2 may be configured to provide various operations, functions, or actions in response to the programming instructions 704 conveyed to the computer system 100 by one or more of the computer readable medium 706, the computer recordable medium 708, and/or the communications medium 710.

The non-transitory computer readable medium could also be distributed among multiple data storage elements, which could be remotely located from each other. Alternatively, the computing device that executes some or all of the stored instructions could be another computing device, such as a server.

The above detailed description describes various features and functions of the disclosed systems, devices, and methods with reference to the accompanying figures. While various aspects and embodiments have been disclosed herein, other aspects and embodiments will be apparent. The various aspects and embodiments disclosed herein are for purposes of illustration and are not intended to be limiting, with the true scope being indicated by the following claims.

It should be understood that arrangements described herein are for purposes of example only. As such, those skilled in the art will appreciate that other arrangements and other elements (e.g. machines, apparatuses, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

What is claimed is:

1. A method for automatic condition analysis of a vehicle tire, the method comprising:
obtaining, by a robotic device and from a first sensor, air pressure data corresponding to the vehicle tire;
based on the air pressure data, performing a first comparison between an air pressure level of the vehicle tire and a threshold air pressure level;
responsive to the air pressure level of the vehicle tire exceeding the threshold air pressure level, rotating, by the robotic device using a mechanical manipulator, the vehicle tire in a first direction;
obtaining, by the robotic device and from a second sensor, sensor data representing an outer surface of the vehicle tire during rotation of the vehicle tire;
performing a second comparison between sensor data representing the outer surface of the vehicle tire and a model for the vehicle tire; and
based on the second comparison, generating, by the robotic device, a diagnostic output that represents a condition of the vehicle tire.

2. The method of claim 1, further comprising:
detecting a position of the vehicle tire using a camera; and
coupling the mechanical manipulator to the vehicle tire based on the position of the vehicle tire; and
wherein rotating the vehicle tire in the first direction comprises:
rotating the vehicle tire in the first direction responsive to coupling the mechanical manipulator to the vehicle tire.

3. The method of claim 1, further comprising:
determining a tire type corresponding to the vehicle tire, wherein the tire type comprises one or more of a brand for the vehicle tire, an estimated distance that the vehicle tire has traveled on a vehicle, and the air pressure level of the vehicle tire; and
obtaining the threshold air pressure level for the vehicle tire from one or more computing devices based on the tire type corresponding to the vehicle tire.

4. The method of claim 1, wherein rotating the vehicle tire in the first direction comprises:
rotating the vehicle tire by a rolling manipulator or by a wheel balancer.

5. The method of claim 1, further comprising:
receiving, by the robotic device and from a sensor coupled to the robotic device, sensor data representing a distance and an orientation of the vehicle tire relative to the robotic device;
providing the sensor data representing the distance and the orientation of the vehicle tire as an input to a neural network, wherein the neural network is trained to provide movement instructions for the mechanical manipulator based on the distance and the orientation of the vehicle tire; and
coupling the mechanical manipulator to the vehicle tire based on control instructions output by the neural network.

6. The method of claim 5,
wherein the vehicle tire is coupled to a vehicle,
wherein the vehicle is associated with a vehicle make identifier and a vehicle model identifier; and
wherein providing the sensor data representing the distance and the orientation of the vehicle tire as the input to the neural network further comprises:
providing an indication of the vehicle make identifier and the vehicle model identifier as a second input to the neural network, and
wherein the neural network is further trained to provide movement instructions for the mechanical manipulator based on the vehicle make identifier and the vehicle model identifier.

7. The method of claim 1, wherein obtaining sensor data representing the outer surface of the vehicle tire during rotation of the vehicle tire comprises:
capturing images of the outer surface of the vehicle tire using a camera; and
wherein performing the second comparison comprises:
performing the second comparison between the images of the outer surface of the vehicle tire and a particular model for the vehicle tire, wherein the particular model is based on a plurality of images of a given vehicle tire based on a type of the vehicle tire.

8. The method of claim 7, further comprising:
based on the second comparison, detecting one or more irregularities on the outer surface of the vehicle tire; and
determining a position for each detected irregularity relative to a valve stem of the vehicle tire.

9. The method of claim 8, wherein generating the diagnostic output that represents the condition of the vehicle tire comprises:
generating one or more images of the outer surface of the vehicle tire, wherein the one or more images depict the one or more irregularities with visual marks representing the position for each irregularity relative to the valve stem of the vehicle tire.

10. The method of claim 1, wherein obtaining sensor data representing the outer surface of the vehicle tire during rotation of the vehicle tire comprises:
receiving depth measurements of the outer surface of the vehicle tire from a photo-electronic sensor; and
determining, based on the depth measurements, a tread mapping of the outer surface of the vehicle tire; and
wherein performing the second comparison comprises:
performing the second comparison between the tread mapping of the outer surface of the vehicle tire and a model tread mapping, wherein the model tread mapping depends on the air pressure level of the vehicle tire; and
determining, based on the second comparison, one or more differences between the tread mapping of the outer surface of the vehicle tire and the model tread mapping.

11. The method of claim 10, further comprising:
estimating, based on the one or more differences, an amount of wear corresponding to the vehicle tire;
estimating, based on the amount of wear, an amount of use left before the vehicle tire reaches a threshold tread limit; and
wherein generating the diagnostic output comprises:
generating the diagnostic output to represent the amount of use left before the vehicle tire reaches the threshold tread limit.

12. The method of claim 10, further comprising:
identifying an irregularity in tread depth of the vehicle tire based on the second comparison; and
estimating a position of the irregularity in tread depth of the vehicle tire relative to a fill valve on the vehicle tire; and
wherein generating the diagnostic output comprises:
generating a visual representation of the vehicle tire comprising a reference point based on the estimated position of the irregularity in tread depth of the vehicle tire.

13. The method of claim 1, further comprising:
detecting, based on the sensor data, a foreign object coupled to the vehicle tire;
determining a position of the foreign object relative to a fill valve on the vehicle tire; and
wherein generating the diagnostic output comprises:
generating a visual representation of the vehicle tire comprising a reference point based on the position of the foreign object relative to the vehicle tire.

14. The method of claim 13, further comprising:
based on the second comparison, detecting a bulge or depression in the vehicle tire; and
wherein generating the diagnostic output comprises:
causing the visual representation of the vehicle tire to further include a second reference point based on a position of the bulge or depression in the vehicle tire.

15. The method of claim 1, further comprising:
illuminating, during rotation of the vehicle tire, at least a portion of the vehicle tire, wherein the robotic device provides illumination via using a light source coupled to the robotic device; and
wherein obtaining sensor data representing the outer surface of the vehicle tire comprises:
obtaining, from the second sensor, first sensor data indicative of light reflections reflecting off the outer surface of the vehicle tire;
adjusting a level of illumination during rotation of the vehicle tire; and
responsive to adjusting the level of illumination, obtaining, from the second sensor, second sensor data indicative of light reflections reflecting off the outer surface of the vehicle tire.

16. The method of claim 15, further comprising:
estimating a position for each reflective material coupled to the vehicle tire, the reflective material detected based on the first sensor data and the second sensor data; and
wherein generating the diagnostic output comprises:
generating the diagnostic output to convey the estimated position for each reflective material coupled to the vehicle tire.

17. The method of claim 1, further comprising:
adjusting a rotation speed of the vehicle tire using the mechanical manipulator during rotation of the vehicle tire; and
based on adjusting the rotation speed of the vehicle tire, determining that the vehicle tire is out of balance.

18. A system for automatic condition analysis of a vehicle tire, the system comprising:
a first sensor;
a second sensor; and
a robotic device having at least one processor and a mechanical manipulator, wherein the robotic device is communicatively coupled to the first sensor and the second sensor, and wherein the robotic device is configured to:
obtain, from the first sensor, air pressure data corresponding to the vehicle tire;
based on the air pressure data, perform a first comparison between an air pressure level of the vehicle tire and a threshold air pressure level;
responsive to the air pressure level of the vehicle tire exceeding the threshold air pressure level, rotate, using the mechanical manipulator, the vehicle tire in a first direction;
obtain, from the second sensor, sensor data representing an outer surface of the vehicle tire during rotation of the vehicle tire;
perform a second comparison between sensor data representing the outer surface of the vehicle tire and a model for the vehicle tire; and
based on the second comparison, generate a diagnostic output that represents a condition of the vehicle tire.

19. The system of claim 18, wherein the robotic device is further configured to:
transmit a type of the vehicle tire to a remote computing system; and
receiving the threshold air pressure level and the model for the vehicle tire from the remote computing system.

20. A non-transitory computer-readable medium configured to store instructions for automatic condition analysis of a vehicle tire, that when executed by a robotic device comprising one or more processors, causes the robotic device to perform operations comprising:
obtaining, from a first sensor, air pressure data corresponding to the vehicle tire;
based on the air pressure data, performing a first comparison between an air pressure level of the vehicle tire and a threshold air pressure level;
responsive to the air pressure level of the vehicle tire exceeding the threshold air pressure level, rotating, using a mechanical manipulator, the vehicle tire in a first direction;
obtaining, from a second sensor, sensor data representing an outer surface of the vehicle tire during rotation of the vehicle tire;
performing a second comparison between sensor data representing the outer surface of the vehicle tire and a model for the vehicle tire; and
based on the second comparison, generating a diagnostic output that represents a condition of the vehicle tire.
